(19) United States
(12) Patent Application Publication
(10) Pub. No.: US 2009/0037180 A1
(43) Pub. Date: Feb. 5, 2009

(54) TRANSCODING METHOD AND APPARATUS

(75) Inventors: Mi-young Kim, Suwon-si (KR); Eun-mi Oh, Seongnam-si (KR); Ki-hyun Choo, Seoul (KR); Jung-hoe Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/947,016

(22) Filed: Nov. 29, 2007

(30) Foreign Application Priority Data
Aug. 2, 2007 (KR) 2007-77815

(51) Int. Cl. G10L 19/00

(52) U.S. Cl. 704/500; 704/E19.001

(57) ABSTRACT

Provided is a method and apparatus for encoding a bitstream, which was encoded by a predetermined method, in another method. By adaptively encoding a bitstream encoded by a predetermined method by selecting a domain in which the encoding is performed for each predetermined band, the bitstream can be efficiently encoded and transmitted and received, and compatibility can be provided.

### CROSS-REFERENCE TO RELATED APPLICATIONS

This application claims the benefit of Korean Patent Application No. 10-2007-0077815, filed on Aug. 2, 2007, in the Korean Intellectual Property Office, the disclosure of which is incorporated herein in its entirety by reference.

### BACKGROUND OF THE INVENTION

1. Field of the Invention

The present invention relates to transcoding, and more particularly, to a method and apparatus for encoding a bitstream, which was encoded by a predetermined method, in another method.

2. Description of the Related Art

An audio signal, such as a voice signal or a music signal, can be encoded using any of various codecs. However, devices for decoding an audio signal, such as MP3 players and Personal Computers (PCs), cannot support all kinds of codec methods for decoding. Thus, a bitstream encoded using a codec not supported by a device needs to be transcoded to a format supported by the device, and then the transcoded bitstream needs to be encoded.

### SUMMARY OF THE INVENTION

The present invention provides a method and apparatus for selecting a domain for encoding a bitstream, which is encoded by a predetermined method, for each predetermined band and adaptively encoding the bitstream.

According to an aspect of the present invention, there is provided a transcoding method comprising: decoding a bitstream encoded by a predetermined method; dividing the decoded result into predetermined bands and selecting a domain for encoding the decoded result for each band according to a pre-set criterion; and encoding the decoded result in the selected domain.

According to another aspect of the present invention, there is provided a computer readable recording medium storing a computer readable program for executing a transcoding method comprising: decoding a bitstream encoded by a predetermined method; dividing the decoded result into predetermined bands and selecting a domain for encoding the decoded result for each band according to a pre-set criterion; and encoding the decoded result in the selected domain.

According to another aspect of the present invention, there is provided a transcoding apparatus comprising: a decoder decoding a bitstream encoded by a predetermined method; a domain selector dividing the decoded result into predetermined bands and selecting a domain for encoding the decoded result for each band according to a pre-set criterion; and an encoder encoding the decoded result in the selected domain.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a system including a transcoding apparatus according to an embodiment of the present invention;

FIG. 2 is a block diagram of a transcoding apparatus according to an embodiment of the present invention;

FIG. 3 is a detailed block diagram of the transcoding apparatus according to an embodiment of the present invention;

FIG. 4 is a block diagram of a frequency domain encoder included in the transcoding apparatus according to an embodiment of the present invention;

FIG. 5 is a block diagram of an apparatus for decoding a bitstream encoded by the transcoding apparatus according to an embodiment of the present invention;

FIG. 6 is a block diagram of a frequency domain decoder included in the apparatus for decoding a bitstream encoded by the transcoding apparatus according to an embodiment of the present invention;

FIG. 7 is a flowchart illustrating a transcoding method according to an embodiment of the present invention;

FIG. 8 is a flowchart illustrating a process of decoding a bitstream encoded by a predetermined method, the process being included in the transcoding method according to an embodiment of the present invention;

FIG. 9 is a flowchart illustrating a process of extracting information that is to be used for encoding from the decoding process or receiving from a user, the process being included in the transcoding method according to an embodiment of the present invention;

FIG. 10 is a flowchart illustrating a process of encoding a decoded signal by adaptively selecting a domain for encoding the decoded signal for each band, the process being included in the transcoding method according to an embodiment of the present invention; and

FIG. 11 is a flowchart illustrating a method of decoding a bitstream encoded by the transcoding method according to an embodiment of the present invention.

### DETAILED DESCRIPTION OF THE PREFERRED EMBODIMENTS

The present invention will be described in detail by explaining preferred embodiments of the invention with reference to the attached drawings.

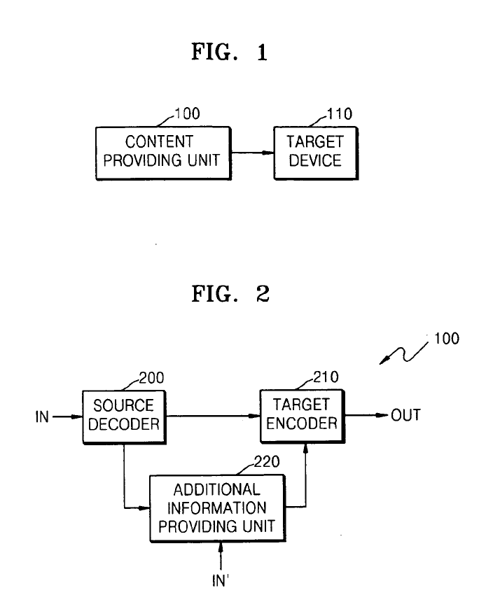

FIG. 1 is a block diagram of a system including a transcoding apparatus according to an embodiment of the present invention.

Referring to FIG. 1, the system includes a content providing device 100 and a target device 110.

The content providing device 100 in the transcoding apparatus according to an embodiment of the present invention, selects a domain for encoding a bitstream, which is encoded by a predetermined method, for each predetermined band, and adaptively encodes the bitstream. The content providing device 100 may be a content server or a Personal Computer (PC).

The target device 110 decodes the bitstream in which the domains encoded for each band are differently and adaptively encoded.

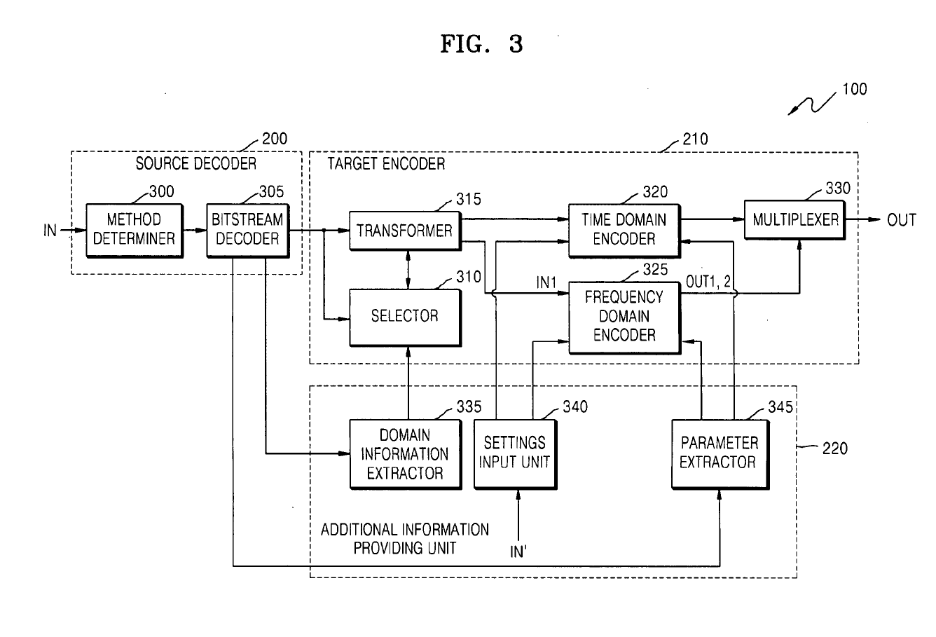

FIG. 2 is a block diagram of a transcoding apparatus according to an embodiment of the present invention.

Referring to FIG. 2, the transcoding apparatus according to an embodiment of the present invention includes a source decoder 200, a target encoder 210, and an additional information providing unit 220.

The source decoder 200 decodes a bitstream encoded by a predetermined method, which is input via an input terminal IN, and outputs a signal, i.e. the decoded result. The method of encoding the bitstream to be decoded by the source decoder 200 is MP3, Advanced Audio Coding (AAC), or Windows Media Audio (WMA).

The target encoder 210 adaptively encodes the signal decoded by the source decoder 200 by selecting a domain for encoding the decoded signal for each predetermined band.

The additional information providing unit 220 extracts additional information that is to be used for the encoding operation in the target encoder 210 from the decoding operation of the source decoder 200 or receives the additional information from a user via an input terminal IN′ and provides the additional information to the target encoder 210. However, the transcoding apparatus according to an embodiment of the present invention does not have to include the additional information providing unit 220.

FIG. 3 is a detailed block diagram of the transcoding apparatus according to an embodiment of the present invention

Referring to FIG. 3, the transcoding apparatus according to an embodiment of the present invention includes a method determiner 300, a bitstream decoder 305, a selector 310, a transformer 315, a time domain encoder 320, a frequency domain encoder 325, and a multiplexer 330. The transcoding apparatus may further include a domain information extractor 335, a settings input unit 340, and a parameter extractor 345.

The source decoder 200 includes the method determiner 300 and the bitstream decoder 305.

The method determiner 300 determines a method by which a bitstream input through the input terminal IN has been encoded. The encoding method is MP3, AAC, or WMA.

The bitstream decoder 305 decodes the bitstream input from the method determiner 300 according to the method determined by the method determiner 300.

However, the source decoder 200 does not have to include the method determiner 300. That is, the bitstream decoder 305 may directly receive the bitstream and decode the received bitstream using a single method that is fixed to a specific format and is generally used by users, such as MP3, without the method determiner 300.

The target encoder 210 includes the selector 310, the transformer 315, the time domain encoder 320, the frequency domain encoder 325, and the multiplexer 330.

The selector 310 selects for each band whether a signal of each band, which is divided by the transformer 315, is encoded by a time domain or a frequency domain. The selector 310 also encodes information on a domain selected for each band and outputs the encoded information to the multiplexer 330.

The transformer 315 divides a signal corresponding to a result decoded by the bitstream decoder 305 in a predetermined band unit and transforms a signal for each band to the time domain or the frequency domain.

In detail, the transformer 315 transforms signal(s) for band(s), which are transformed to the frequency domain, from the time domain to the frequency domain in a first transform method and transforms the signal(s) from the time domain to the frequency domain in a second transform method in order to apply a psychoacoustic model. A spectrum transformed in the first transform method is used to encode a signal of a band that is to be encoded in the frequency domain, and a signal transformed in the second transform method is used to apply the psychoacoustic model to the signal of the band that is to be encoded in the frequency domain. The psychoacoustic model is a mathematical model for screening in the human auditory system.

For example, the transformer 315 may transform a signal of a predetermined band to the frequency domain by Modified Discrete Cosine Transform (MDCT) corresponding to the first transform method and express the transformed signal as a real number part, and transform the signal to the frequency domain by Modified Discrete Sine Transform (MDST) corresponding to the second transform method and express the transformed signal as an imaginary number part. The signal transformed by MDCT and expressed as the real number part is used to encode the signal of the predetermined band, and the signal transformed by MDST and expressed as the imaginary number part is used to apply the psychoacoustic model to the signal of the predetermined band. Accordingly, since phase information of a signal can be additionally expressed, a miss match occurring by performing Discrete Fourier Transform (DFT) for a signal corresponding to the time domain and quantizing coefficients of MDCT can be prevented.

The transformer 315 can use any if all transform methods of receiving a signal expressed in the time domain and simultaneously expressing the signal in the time domain and the frequency domain. In more detail, a flexible transform method of transforming a signal expressed in the time domain to the frequency domain and expressing a signal of a predetermined band in the frequency domain by properly adjusting a temporal resolution for each band is used. Additionally, a signal for applying the psychoacoustic model by means of an imaginary number is generated. An example of the transform method is Frequency Variable Modulated Lapped Transform (FV-MLT).

The time domain encoder 320 encodes the signal(s) of band(s), which have been determined by the selector 310 to be encoded in the time domain and transformed to the time domain by the transformer 315, in the time domain. An example of an encoding method used by the time domain encoder 320 is Code Excited Linear Prediction (CELP) but not limited thereto.

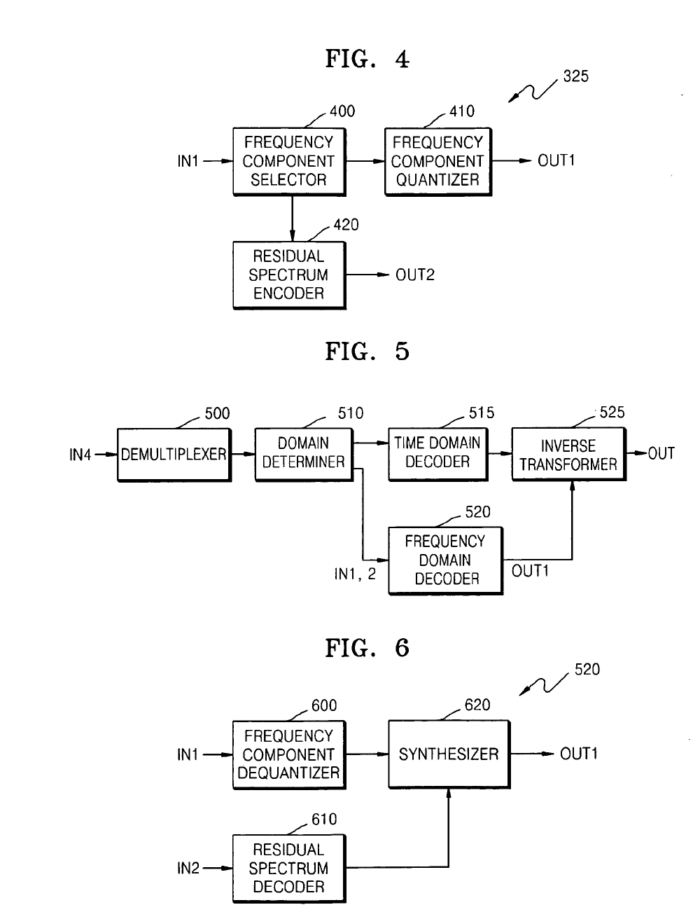

The frequency domain encoder 325 encodes the spectrum(-ra) of band(s), which have been determined by the selector 310 to be encoded in the frequency domain and transformed to the frequency domain by the transformer 315, in the frequency domain. An encoding operation performed by the frequency domain encoder 325 will be described with reference to FIG. 4 later.

The multiplexer 330 generates a bitstream by multiplexing the information on a domain selected for each band, which is encoded by the selector 310, and the signal(s) of band(s), which were encoded by the time domain encoder 320, or the spectrum(-ra) of band(s), which were encoded by the frequency domain encoder 325, and outputs the bitstream via an output terminal OUT.

The additional information providing unit 220 can include the domain information extractor 335, the settings input unit 340, and the parameter extractor 345. However, the transcoding apparatus according to an embodiment of the present invention does not have to include the additional information providing unit 220. The additional information providing unit 220 does not have to include all of the domain information extractor 335, the settings input unit 340, and the parameter extractor 345. That is, the additional information providing unit 220 can selectively include at least one of the domain information extractor 335, the settings input unit 340, and the parameter extractor 345.

The domain information extractor 335 extracts pre-set information, which is to be used for selecting a domain for encoding a signal of each band in the selector 310, in a decoding process of the bitstream decoder 305.

An example of the pre-set information is information on a format of a bitstream. The domain information extractor 335 extracts information on whether the format of the bitstream is a format encoded by a voice codec or an audio codec, and the selector 310 selects using the information on the format whether a signal of each band is encoded in the time domain or the frequency domain.

The settings input unit 340 receives setting(s) to be used for performing encoding in the time domain encoder 320 or the frequency domain encoder 325 from a user. Examples of the settings received by the settings input unit 340 from the user are parameters such as a bit rate, sampling, transformed sound quality, and a transform speed. The time domain encoder 320 and the frequency domain encoder 325 perform encoding according to the settings received by the settings input unit 340 from the user.

The parameter extractor 345 extracts pre-set parameters in the decoding process of the bitstream decoder 305 in order to use the information generated in the decoding process of the bitstream decoder 305 in the time domain encoder 320 or the frequency domain encoder 325. The time domain encoder 320 and the frequency domain encoder 325 perform encoding using the extracted parameter(s).

FIG. 4 is a block diagram of the frequency domain encoder 325 included in the transcoding apparatus according to an embodiment of the present invention.

Referring to FIG. 4, the frequency domain encoder 325 includes a frequency component selector 400, a frequency component quantizer 410, and a residual spectrum encoder 420.

The frequency component selector 400 selects important frequency component(s) according to a pre-set criterion from the spectrum(-ra) of band(s), which were determined by the selector 310 to be encoded in the frequency domain and transformed to the frequency domain by the transformer 315.

Examples of the pre-set criterion for selecting the frequency component in the frequency component selector 400 are: first, calculating a Signal-to-Mask Ratio (SMR) value and selecting a frequency component corresponding to a signal having a value greater than a masking threshold; second, selecting a frequency component by extracting a spectral peak considering a predetermined weight; and third, calculating a Signal-to-Noise Ratio (SNR) value for each band and selecting a frequency component having a peak value greater than a predetermined value from a sub-band having the lowest SNR value. Any of the three examples can be independently performed, and at least two of them may be mixed and performed.

The frequency component quantizer 410 quantizes the frequency component(s) selected by the frequency component selector 400 and outputs the quantization result via an output terminal OUT1.

The residual spectrum encoder 420 extracts a residual spectrum excluding the frequency component(s) selected by the frequency component selector 400, encodes the extracted residual spectrum in a method different from that of encoding the frequency component(s) selected by the frequency component selector 400, and outputs an encoding result of the residual spectrum via the output terminal OUT1. The encoding performed by the residual spectrum encoder 420 can be achieved by calculating per-band energy value(s) of the residual spectrum excluding the frequency component(s) selected by the frequency component selector 400.

FIG. 5 is a block diagram of an apparatus for decoding a bitstream encoded by the transcoding apparatus according to an embodiment of the present invention.

Referring to FIG. 5, the apparatus for decoding a bitstream encoded by the transcoding apparatus according to an embodiment of the present invention includes a demultiplexer 500, a domain determiner 510, a time domain decoder 515, a frequency domain decoder 520, and an inverse transformer 525.

The demultiplexer 500 demultiplexes a bitstream encoded by the transcoding apparatus, which is received via an input terminal IN. The demultiplexer 500 also demultiplexes information on a domain in which each band has been encoded, signal(s) of band(s) encoded in the time domain, and spectrum(-ra) of band(s) encoded in the frequency domain.

The domain determiner 510 receives the demultiplexed information on a domain in which each band is encoded and determines a domain in which each band is encoded by an encoder.

The time domain decoder 515 decodes signal(s) of band(s), which were determined by the domain determiner 510 that the signal(s) have been encoded in the time domain, in the time domain. An example of a decoding method used by the time domain decoder 515 is CELP but not limited thereto.

The frequency domain decoder 520 decodes spectrum(-ra) of band(s), which were determined by the domain determiner 510 that the signal(s) have been encoded in the frequency domain, in the frequency domain. An example of a decoding method used by the frequency domain decoder 520 will be described with reference to FIG. 6 later.

The inverse transformer 525 generates a single signal corresponding to the time domain by inverse transforming the signal(s) of band(s) decoded by the time domain decoder 515 and the spectrum(-ra) of band(s) decoded by the frequency domain decoder 520 in an inverse process of the transformation performed by the transformer 315 and synthesizing them and outputs the generated signal via an output terminal OUT.

FIG. 6 is a block diagram of the frequency domain decoder 520 included in the apparatus for decoding a bitstream encoded by the transcoding apparatus according to an embodiment of the present invention.

Referring to FIG. 6, the frequency domain decoder 520 includes a frequency component dequantizer 600, a residual spectrum decoder 610, and a synthesizer 620.

The frequency component dequantizer 600 dequantizes frequency component(s) selected and encoded by the encoder.

The residual spectrum decoder 610 decodes a residual spectrum encoded by the encoder.

The synthesizer 620 synthesizes the frequency component(s) dequantized by the frequency component dequantizer 600 and the residual spectrum decoded by the residual spectrum decoder 610 and outputs the synthesizing result via an output terminal OUT1.

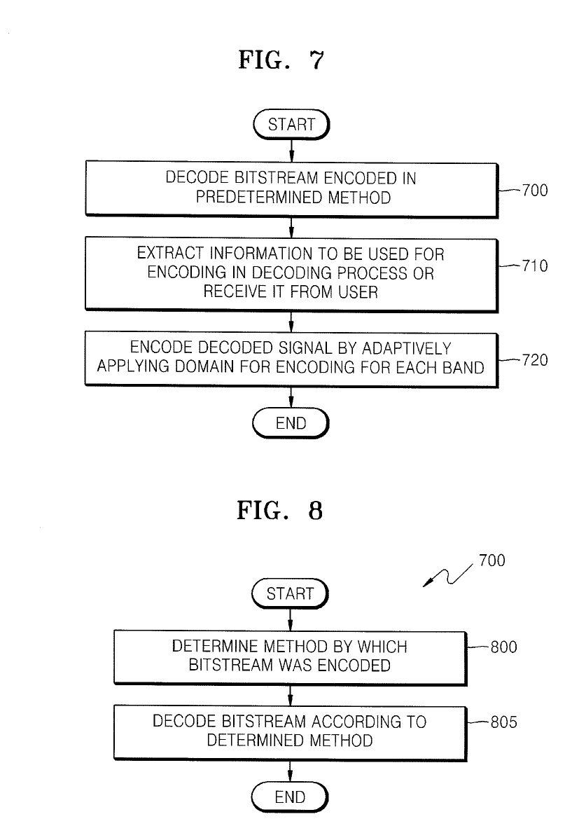

FIG. 7 is a flowchart illustrating a transcoding method according to an embodiment of the present invention.

Referring to FIG. 7, an input bitstream encoded by a predetermined method is decoded in operation 700. The method of encoding the bitstream to be decoded in operation 700 is MP3, AAC, or WMA.

In operation 710, additional information that is to be used for the encoding operation in operation 720 is extracted from the decoding operation in operation 700 or input by a user. However, the transcoding method according to an embodiment of the present invention does not have to perform operation 710.

In operation 720, a domain for encoding the signal decoded in operation 700 for each predetermined band is selected using the additional information extracted or input in operation 710, and each band is adaptively encoded.

FIG. 8 is a flowchart illustrating a process of decoding a bitstream encoded by a predetermined method, the process (operation 700 of FIG. 7) being included in the transcoding method according to an embodiment of the present invention.

Referring to FIG. 8, a method by which an input bitstream has been encoded is determined in operation 800. The encoding method is MP3, AAC, or WMA.

In operation 805, the bitstream is decoded according to the method determined in operation 800.

However, operation 700 of FIG. 7 does not have to include operation 800. That is, the bitstream may be directly received and decoded using a single method that is fixed to a specific format and is generally used by users, such as MP3, in operation 805 without operation 800.

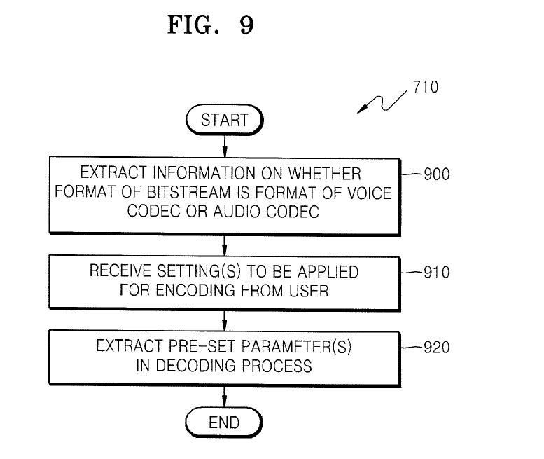

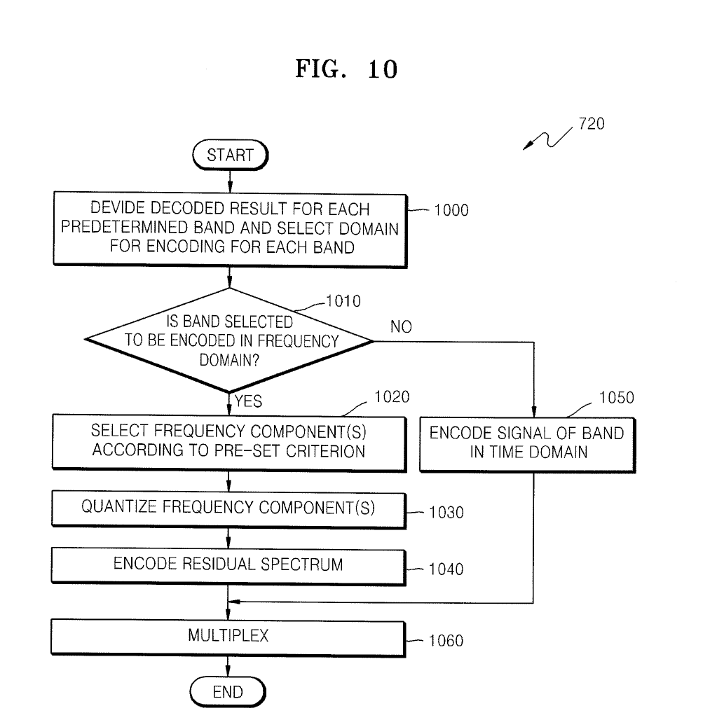

FIG. 9 is a flowchart illustrating a process of extracting information that is to be used for encoding from the decoding process or receiving from a user, the process (operation 710 of FIG. 7) being included in the transcoding method according to an embodiment of the present invention. However, the transcoding method according to an embodiment of the present invention does not have to include all of operations 900 to 920. That is, t the transcoding method according to an embodiment of the present invention can selectively include at least one of operations 900 to 920.

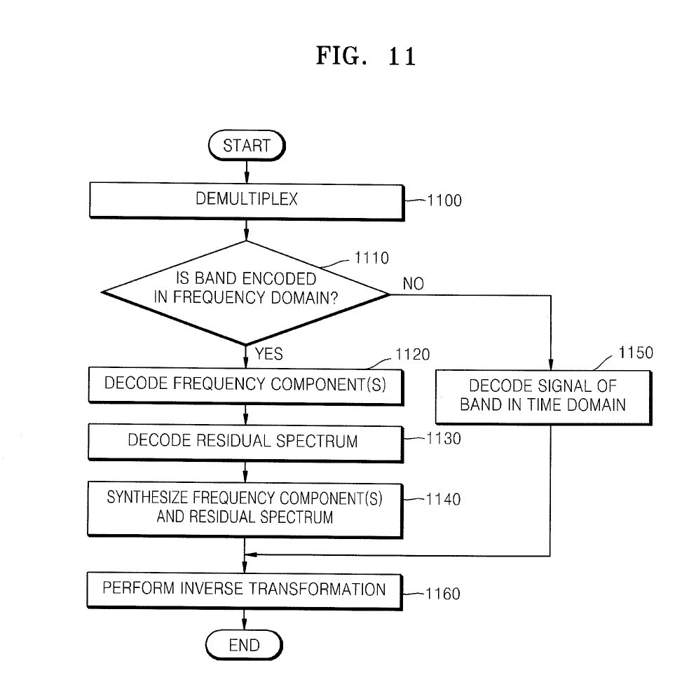

Referring to FIG. 9, in operation 900, pre-set information, which is to be used for selecting a domain for encoding a signal of each band in operation 1010 of FIG. 10, is extracted in the decoding process of operation 805 of FIG. 8.

An example of the pre-set information is information on a format of a bitstream. In operation 900, information on whether the format of the bitstream is a format encoded by a voice codec or an audio codec is extracted, and in operation 1010 of FIG. 10, whether a signal of each band is encoded in the time domain or the frequency domain is selected using the information on the format.

In operation 910, setting(s) to be used for performing encoding in operations 1020 to 1040 or operation 1050 of FIG. 10 are input by a user. Examples of the settings input by the user in operation 910 are parameters such as a bit rate, sampling, transformed sound quality, and a transform speed. In operations 1020 to 1040 or operation 1050 of FIG. 10, encoding is performed according to the settings input by the user in operation 910.

In operation 920, pre-set parameters are extracted in the decoding process of operation 805 of FIG. 8 in order to use the information, which has been generated in the decoding process of operation 805 of FIG. 8, in operations 1020 to 1040 or operation 1050 of FIG. 10. In operations 1020 to 1040 and operation 1050 of FIG. 10, encoding is performed using the extracted parameter(s).

FIG. 10 is a flowchart illustrating a process of encoding a decoded signal by adaptively selecting a domain for encoding the decoded signal for each band, the process (operation 720 of FIG. 7) being included in the transcoding method according to an embodiment of the present invention.

Referring to FIG. 10, in operation 1000, whether a signal of each band divided in operation 805 of FIG. 8 is encoded in the time domain or the frequency domain is selected for each band, and a signal corresponding to a result decoded in operation 805 is divided in a predetermined band unit and transformed for each band to the time domain or the frequency domain according to a selected domain.

In detail, in operation 1000, signal(s) for band(s), which are transformed to the frequency domain, are transformed from the time domain to the frequency domain in the first transform method, and transformed from the time domain to the frequency domain in the second transform method in order to apply a psychoacoustic model. A spectrum transformed in the first transform method is used to encode a signal of a band that is to be encoded in the frequency domain, and a signal transformed in the second transform method is used to apply the psychoacoustic model to the signal of the band that is to be encoded in the frequency domain. The psychoacoustic model is a mathematical model for screening in the human auditory system.

For example, in operation 1000, a signal of a predetermined band may be transformed to the frequency domain by MDCT corresponding to the first transform method and expressed as a real number part, and also transformed to the frequency domain by MDST corresponding to the second transform method and expressed as an imaginary number part. The signal transformed by MDCT and expressed as the real number part is used to encode the signal of the predetermined band, and the signal transformed by MDST and expressed as the imaginary number part is used to apply the psychoacoustic model to the signal of the predetermined band. Accordingly, since phase information of a signal can be additionally expressed, a miss match occurring by performing DFT for a signal corresponding to the time domain and quantizing coefficients of MDCT can be prevented.

Operation 1000 can be implemented by any if all transform methods of receiving a signal expressed in the time domain and simultaneously expressing the signal in the time domain and the frequency domain. In more detail, a flexible transform method of transforming a signal expressed in the time domain to the frequency domain and expressing a signal of a predetermined band in the frequency domain by properly adjusting a temporal resolution for each band is used. Additionally, a signal for applying the psychoacoustic model by means of an imaginary number is generated. An example of the transform method is FV-MLT.

In operation 1010, it is determined for each band whether a domain selected in operation 1000 as a domain for encoding is the time domain or the frequency domain.

In operation 1020, important frequency component(s) according to a pre-set criterion are selected from the spectrum(-ra) of band(s), which were determined in operation 1010 to be encoded in the frequency domain.

Examples of the pre-set criterion for selecting the frequency component in operation 1020 are: first, calculating a SMR value and selecting a frequency component corresponding to a signal having a value greater than a masking threshold; second, selecting a frequency component by extracting a spectral peak considering a predetermined weight; and third, calculating a SNR value for each band and selecting a frequency component having a peak value greater than a predetermined value from a sub-band having the lowest SNR value. Any of the three examples can be independently performed, and at least two of them may be mixed and performed.

In operation 1030, the frequency component(s) selected in operation 1000 are quantized.

In operation 1040, a residual spectrum excluding the frequency component(s) selected in operation 1000 is extracted and encoded by a method different from that of encoding the frequency component(s) selected in operation 1000. The encoding performed in operation 1040 can be achieved by calculating per-band energy value(s) of the residual spectrum excluding the frequency component(s) selected in operation 1020.

In operation 1050, the signal(s) of band(s), which have been determined in operation 1010 to be encoded in the time domain, are encoded in the time domain. An example of an encoding method used in operation 1050 is CELP but not limited thereto.

In operation 1060, a bitstream is generated by multiplexing the information on a domain selected for each band, which was encoded in operation 1000, the frequency component(s) quantized in operation 1030, and the spectrum(-ra) encoded in operation 1040.

FIG. 11 is a flowchart illustrating a method of decoding a bitstream encoded by the transcoding method according to an embodiment of the present invention.

Referring to FIG. 11, in operation 1100, a bitstream encoded by a transcoding apparatus, which is received from an encoder, is demultiplexed. In addition, in operation 1100, information on a domain in which each band has been encoded, signal(s) of band(s) encoded in the time domain, and spectrum(-ra) of band(s) encoded in the frequency domain are demultiplexed.

In operation 1110, a domain in which each band was encoded by the encoder is determined using the information on a domain in which each band was encoded, the information demultiplexed in operation 1100.

In operation 1120, frequency component(s) selected and encoded by the encoder are dequantized with respect to band(s) determined in operation 1110 as band(s) encoded in the frequency domain.

In operation 1130, a residual spectrum encoded by the encoder is decoded.

In operation 1140, the frequency component(s) dequantized in operation 1120 and the residual spectrum decoded in operation 1130 are synthesized.

In operation 1150, signal(s) of band(s) determined in operation 1110 as signal(s) encoded in the time domain are decoded in the time domain. An example of a decoding method used in operation 1150 is CELP but not limited thereto.

In operation 1160, a single signal corresponding to the time domain is generated by inverse transforming and synthesizing the spectrum(-ra) decoded in operation 1140 and the signal(s) of band(s) decoded in operation 1150 in an inverse process of the transformation performed in operation 1000 of FIG. 10.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet).

As described above, according to the present invention, a bitstream encoded by a predetermined method is adaptively encoded by selecting a domain in which encoding is performed for each predetermined band.

By selecting a domain in which encoding is performed for each predetermined band and adaptively performing the encoding, even a bitstream encoded by a conventional codec can be efficiently encoded and transmitted. In addition, compatibility can be provided by decoding and reproducing a bitstream encoded by a conventional codec even in a device for decoding an adaptively encoded bitstream by selecting a domain for encoding for each predetermined band.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A transcoding method comprising:
decoding a bitstream encoded by a predetermined method;
dividing the decoded result into predetermined bands and selecting a domain for encoding the decoded result for each band according to a pre-set criterion; and
encoding the decoded result in the selected domain.

2. The transcoding method of claim 1, wherein the selecting comprises selecting one of a time domain and a frequency domain.

3. The transcoding method of claim 1, further comprising extracting information pre-set in the decoding,
wherein the selecting comprises selecting a domain for encoding the decoded result for each band using the extract information.

4. The transcoding method of claim 1, further comprising receiving setting(s) to be applied to the encoding from a user,
wherein the encoding comprises encoding the decoded result according to the received setting(s).

5. The transcoding method of claim 1, wherein the decoding comprises:
determining a method by which the bitstream was encoded; and
decoding the bitstream according to the determined method.

6. The transcoding method of claim 1, further comprising extracting, in the decoding, pre-set parameter(s) to be used in the encoding,
wherein the encoding comprises encoding the decoded result in the selected domain using the extracted parameter(s).

7. The transcoding method of claim 1, wherein the encoding comprises:
selecting frequency component(s) according to a pre-set criterion in spectrum(-ra) of band(s) selected to be encoded in the frequency domain in the selecting; and
encoding the selected frequency component(s).

8. The transcoding method of claim 7, further comprising encoding a residual spectrum excluding the selected frequency component(s) selected from among the spectrum(-ra).

9. The transcoding method of claim 8, wherein the encoding of the residual spectrum comprises calculating and encoding energy value(s) of the residual spectrum of each band.

10. A transcoding apparatus comprising:
a decoder decoding a bitstream encoded by a predetermined method;
a domain selector dividing the decoded result into predetermined bands and selecting a domain for encoding the decoded result for each band according to a pre-set criterion; and
an encoder encoding the decoded result in the selected domain.

11. The transcoding apparatus of claim 10, wherein the domain selector selects one of a time domain and a frequency domain.

12. The transcoding apparatus of claim 10, further comprising an information extractor extracting information pre-set by the decoder,
wherein the domain selector selects a domain for encoding the decoded result for each band using the extract information.

13. The transcoding apparatus of claim 10, further comprising a settings input unit receiving setting(s), which are to be applied to the encoding performed by the encoder, from a user,
wherein the encoder encodes the decoded result according to the received setting(s).

14. The transcoding apparatus of claim 10, wherein the decoder comprises:
a method determiner determining a method in which the bitstream was encoded; and
a bitstream decoder decoding the bitstream according to the determined method.

15. The transcoding apparatus of claim 10, further comprising a parameter extractor extracting, in a decoding process of the decoder, pre-set parameter(s) to be used in the encoder,
wherein the encoder encodes the decoded result in the selected domain using the extracted parameter(s).

16. The transcoding apparatus of claim 10, wherein the encoder comprises:
a frequency component selector selecting frequency component(s) according to a pre-set criterion in spectrum(-ra) of band(s) selected to be encoded in the frequency domain by the domain selector; and
a frequency component encoder encoding the selected frequency component(s).

17. The transcoding apparatus of claim 16, further comprising a residual spectrum encoder encoding a residual spectrum excluding the selected frequency component(s) from among the spectrum(-ra).

18. The transcoding apparatus of claim 17, wherein the residual spectrum encoder calculates and encodes energy value(s) of the residual spectrum of each band.

19. A transcoding method comprising:
decoding a bitstream encoded by a predetermined method;
selecting frequency component(s) according to a pre-set criterion from the decoded result; and
encoding the selected frequency component(s).

20. The transcoding method of claim 19, further comprising encoding a residual spectrum excluding the selected frequency component(s) from the decoded result.

21. The transcoding method of claim 20, wherein the encoding of the residual spectrum comprises calculating and encoding energy value(s) of the residual spectrum of each band.

22. The transcoding method of claim 19, further comprising receiving setting(s) to be applied to the encoding from a user,
wherein the encoding comprises encoding the selected frequency component(s) according to the received setting(s).

23. The transcoding method of claim 19, wherein the decoding comprises:
determining a method in which the bitstream was encoded; and
decoding the bitstream according to the determined method.

24. The transcoding method of claim 19, further comprising extracting, in the decoding, pre-set parameter(s) to be used in the encoding,
wherein the encoding comprises encoding the selected frequency component(s) using the extracted parameter(s).
